(19) United States
(12) Patent Application Publication
(10) Pub. No.: US 2017/0003442 A1
(43) Pub. Date: Jan. 5, 2017

(54) Backlight module Comprising Quantum Dot Strips and Liquid Crystal Display Device

(71) Applicant: Shenzhen China Star Optoelectronics Technology Co., Ltd., Shenzhen, Guangdong (CN)

(72) Inventors: Shihhsiang Chen, Shenzhen, Guangdong (CN); Chengwen Que, Shenzhen, Guangdong (CN); Dehua Li, Shenzhen, Guangdong (CN)

(73) Assignee: Shenzhen China Star Optoelectronics Technology Co., Ltd., Shenzhen, Guangdong (CN)

(21) Appl. No.: 14/442,142

(22) PCT Filed: Mar. 9, 2015
(86) PCT No.: PCT/CN2015/073862

§ 371 Date: May 12, 2015

(30) Foreign Application Priority Data
Mar. 2, 2015 (CN) 201510092198.5

(51) Int. Cl. F21V 8/00

(52) U.S. Cl. CPC G02B 6/0088; G02B 6/0026; G02B 6/0085

(57) ABSTRACT

A backlight module having quantum dot (QD) strips is provided. The backlight module includes a back bezel, a light guide plate (LGP) disposed on the back bezel, and a light source fixed at one side of the LGP. A QD strip is disposed between the light source and the LGP. A reflective layer is coated on or adheres to partial periphery of the QD strip, an incident opening and an emergent opening are formed on the periphery of the QD strip because of the reflective layer. The incident opening faces towards the light source. The emergent opening faces towards the LGP, and a width of the emergent opening is smaller than a width of the incident opening. The present invention also proposes a liquid crystal display using the backlight module.

### BACKGROUND OF THE INVENTION

1. Field of the Invention

The present invention relates to the technical field of liquid crystal displays (LCDs), and more particularly, to a backlight module comprising quantum dot (QD) strips and an LCD device comprising the backlight module.

2. Description of the Prior Art

The prosperity of flat panel displays results from the progress of the optoelectronic and semiconductor technology. Among all kinds of flat panel displays, LCDs have become the mainstream on the market owing to their prominent features of high efficiency of space utilization, low consumption power, no radiation, and low electromagnetic interference.

An LCD roughly comprises a liquid crystal panel and a backlight module. The liquid crystal panel is unable to generate light itself so the backlight module is disposed beneath the liquid crystal panel and provides a required surface source for the liquid crystal panel. The liquid crystal panel shows images with the surface source.

With the development of the society, users become pickier and pickier about the quality of images shown on the LCD. The improvement of chroma of LED strips in the backlight module is beneficial for increasing color saturation of images. In the conventional technology, another QD strip is disposed in the backlight module. The QD technique is the technique of semiconductor nanomaterials that electrons are confined in a certain range. QDs are fabricated by mini compound crystals. The size of the mini compound crystals varies from 1 nm to 100 nm. The QD technique is used in the illumination and display field. Wavelength of the incident light is controlled and changed by using the QDs with different sizes of crystals. As long as the size of crystals is exactly controlled, color will be precisely controlled. The color range will be quite wide as well. The QDs have been widely adopted in the field of the LCD technology. Generally, the QDs are packaged in transparent glass tubes to form QD strips.

FIG. 1 shows a longitudinal section of a conventional QD strip 10. FIG. 2 shows a transverse section of the conventional QD strip 10. FIG. 1 shows that an effective zone 11 located in the middle of the QD strip 10 and two ineffective zones 12 located at two terminals of the QD strip 10. FIG. 2 shows that the QD strip 10 roughly comprises a function portion 13 located in the QD strip 10 and a package portion 14 packing the function portion 13. The function portion 13 is usually fabricated from material of QDs. The package portion 14 is usually fabricated from material of glass. The QD strip 10 is usually fixed and placed between a back light source and a light guide plate (LGP) with a fixing bracket in the backlight module of the LCD.

However, the QD strip consumes a larger amount of light. It is necessary to adopt double-side light entry or multiple-side light entry for most of the time to fulfill the demand of luminous flux of the LCD device. Accordingly, it is necessary to use more QD strips, which implies that production cost increases.

### SUMMARY OF THE INVENTION

The present invention proposes a backlight module comprising QD strips. Under the premise of reduction of light loss, the backlight module successfully concentrates light. While a larger demand of luminous flux is satisfied, the use of the QD strip does not increase in numbers. Thus, the overall production cost is reduced.

According to the present invention, a backlight module comprising quantum dot (QD) strips is provided. The backlight module comprises a back bezel, a light guide plate (LGP) disposed on the back bezel, and a light source fixed at one side of the LGP. A QD strip is disposed between the light source and the LGP. A reflective layer is coated on or adheres to partial periphery of the QD strip, an incident opening and an emergent opening are formed on the periphery of the QD strip because of the reflective layer. The incident opening faces towards the light source. The emergent opening faces towards the LGP, and a width of the emergent opening is smaller than a width of the incident opening.

Furthermore, a mounting bracket for QD strips is disposed on the back bezel, the mounting bracket for QD strips comprises a receiving slot connected to the mounting bracket for QD strips itself, an incident slot, and an emergent slot, the receiving slot is used for emplacing the QD strip, the incident slot corresponds to the incident opening, and the emergent slot corresponds to the emergent opening.

Furthermore, the reflective layer is symmetrically disposed on upper and lower portions of the QD strip, and the incident opening and the emergent opening are symmetrically disposed opposite on both sides of the QD strip.

Furthermore, a width of the incident opening is not smaller than the width of the light source, and the width of the emergent opening is not larger than the thickness of a light input surface of the LGP.

Furthermore, the light source comprises at least one light-emitting diode (LED) strip.

Furthermore, a width of the incident opening is not smaller than the width of the light source, and the width of the emergent opening is not larger than the thickness of a light input surface of the LGP.

Furthermore, a width of the incident opening is not smaller than the width of the light source, and the width of the emergent opening is not larger than the thickness of a light input surface of the LGP.

Furthermore, the backlight module further comprises a reflector, and the reflector is disposed between the back bezel and the LGP.

Furthermore, the backlight module further comprises an optical film unit, the optical film unit is disposed above the LGP, the mounting bracket for QD strips comprises an upper portion which extends above the LGP, and at least a part of the optical film unit is placed on the upper portion.

Furthermore, a heat sink is disposed on the back bezel and the light source is disposed on the heat sink.

According to the present invention, a liquid crystal display (LCD) device comprises a liquid crystal panel and a backlight module disposed opposite to the liquid crystal panel. The backlight module is used for supplying the liquid crystal panel with an illuminating light source so that the liquid crystal panel can show images. The backlight module comprises a back bezel, a light guide plate (LGP) disposed on the back bezel, and a light source fixed at one side of the LGP. A QD strip is disposed between the light source and the LGP. A reflective layer is coated on or adheres to partial periphery of the QD strip, an incident opening and an emergent opening are formed on the periphery of the QD strip because of the reflective layer. The incident opening faces towards the light source. The emergent opening faces towards the LGP, and a width of the emergent opening is smaller than a width of the incident opening.

Furthermore, a mounting bracket for QD strips is disposed on the back bezel, the mounting bracket for QD strips comprises a receiving slot connected to the mounting bracket for QD strips itself, an incident slot, and an emergent slot, the receiving slot is used for emplacing the QD strip, the incident slot corresponds to the incident opening, and the emergent slot corresponds to the emergent opening.

Furthermore, the reflective layer is symmetrically disposed on upper and lower portions of the QD strip, and the incident opening and the emergent opening are symmetrically disposed opposite on both sides of the QD strip.

Furthermore, a width of the incident opening is not smaller than the width of the light source, and the width of the emergent opening is not larger than the thickness of a light input surface of the LGP.

Furthermore, the light source comprises at least one light-emitting diode (LED) strip.

Furthermore, a width of the incident opening is not smaller than the width of the light source, and the width of the emergent opening is not larger than the thickness of a light input surface of the LGP.

Furthermore, a width of the incident opening is not smaller than the width of the light source, and the width of the emergent opening is not larger than the thickness of a light input surface of the LGP.

Furthermore, the backlight module further comprises a reflector, and the reflector is disposed between the back bezel and the LGP.

Furthermore, the backlight module further comprises an optical film unit, the optical film unit is disposed above the LGP, the mounting bracket for QD strips comprises an upper portion which extends above the LGP, and at least a part of the optical film unit is placed on the upper portion.

Furthermore, a heat sink is disposed on the back bezel and the light source is disposed on the heat sink.

The beneficial effect is as follows:

A reflective layer in the backlight module proposed by the present embodiment of the present invention is coated on or adheres to partial periphery of the QD strip. An incident opening and an emergent opening are formed on the periphery of the QD strip because of the reflective layer. Also, the width of the emergent opening is smaller than a width of the incident opening. The light generated by the light source emits into the QD strip through the incident opening with a larger width. Some of the light is reflected by the reflective layer and then emits into the QD strip. Finally, the light emits out of the emergent opening with a smaller width and enters an LGP. Therefore, the QD strip comprising the reflective layer has functions of light mixing and light condensing. While a larger demand of luminous flux is satisfied, the use of the QD strip does not increase in numbers. So the overall production cost is reduced.

### BRIEF DESCRIPTION OF THE DRAWINGS

FIG. 1 shows a longitudinal section of a conventional QD strip.

FIG. 2 shows a transverse section of the conventional QD strip.

FIG. 3 is a schematic diagram of an LCD device according to an embodiment of the present invention.

FIG. 4 is a schematic diagram of a backlight module according to an embodiment of the present invention.

FIG. 5 shows an enlargement of part of the backlight module according to an embodiment of the present invention.

FIG. 6 illustrates a travel route of light generated by the light source emitting into the QD strip.

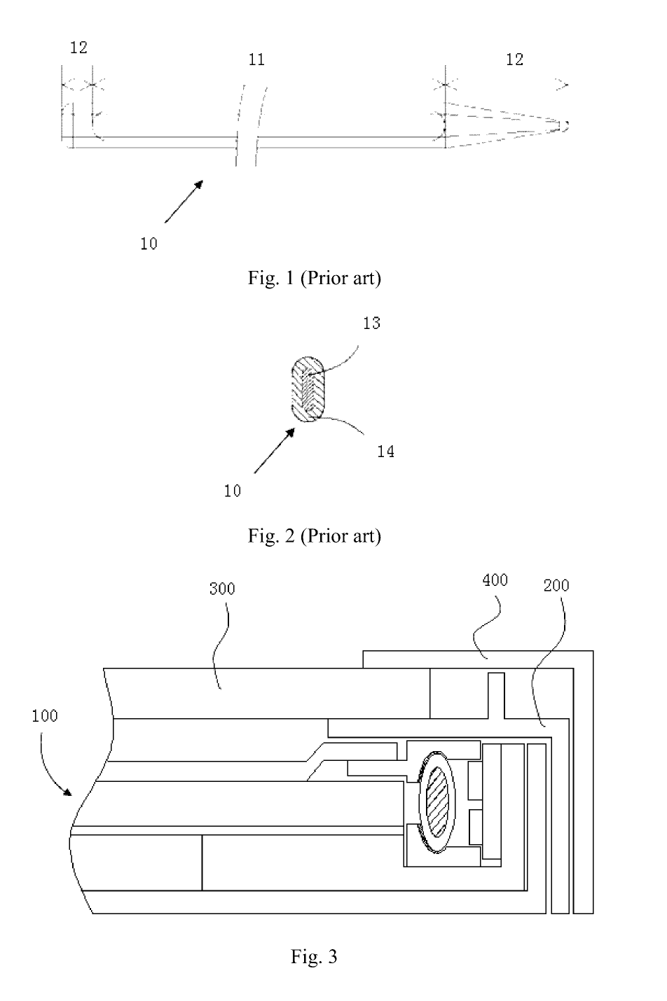

### DETAILED DESCRIPTION OF THE PREFERRED EMBODIMENTS

For better understanding embodiments of the present invention, the following detailed description taken in conjunction with the accompanying drawings is provided. Apparently, the accompanying drawings are merely for some of the embodiments of the present invention.

Any ordinarily skilled person in the technical field of the present invention could still obtain other accompanying drawings without use laborious invention based on the present accompanying drawings.

FIG. 3 is a schematic diagram showing the structure of an LCD device according to an embodiment of the present invention. The LCD device comprises a backlight module 100, a plastic frame 200, a liquid crystal panel 300, and a front frame 400. The plastic frame 200 is disposed on the backlight module 100. The liquid crystal panel 300 is disposed on the plastic frame 200. The front frame 400 is connected to the liquid crystal panel 300 and the backlight module 100. The liquid crystal panel 300 is disposed opposite to the backlight module 100. The backlight module 100 supplies the liquid crystal panel 300 with an illuminating light source so that the liquid crystal panel 300 can show images.

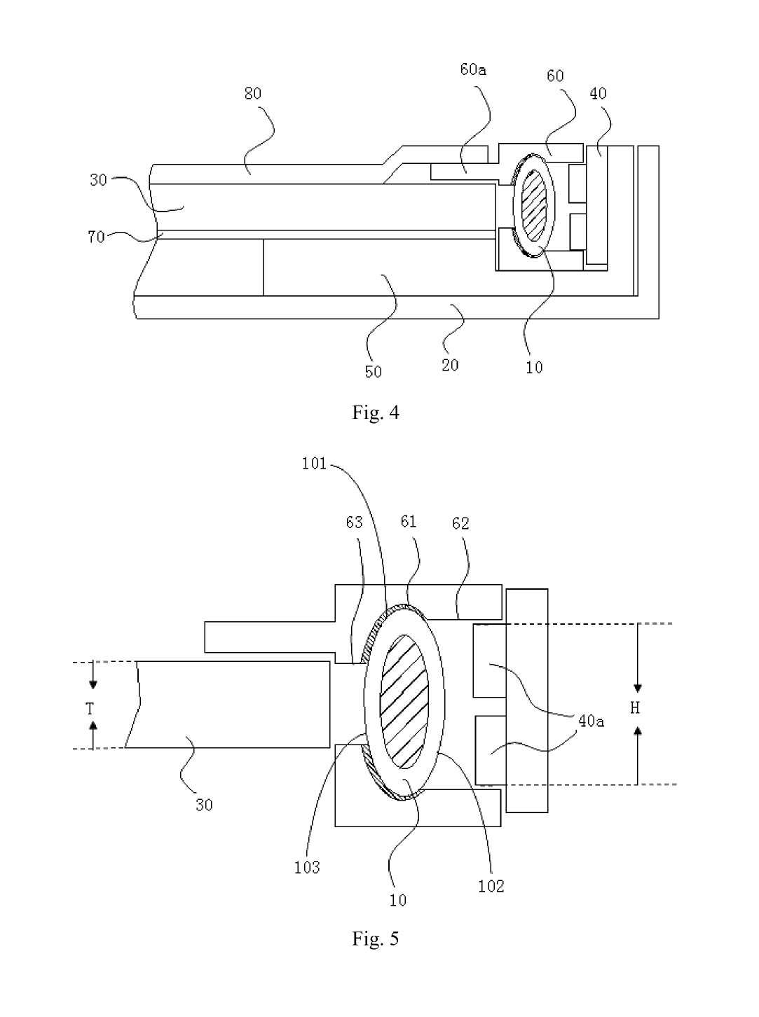

Please refer to FIG. 4. The backlight module 100 comprises at least a back bezel 20, an LGP 30, and a light source 40. The LGP 30 is disposed on the back bezel 20. The light source 40 is fixed at one side of the LGP 30 and disposed on a heat sink 50. A QD strip 10 is disposed between the light source 40 and the LGP 30 and installed in a mounting bracket for QD strips 60.

The backlight module 100 further comprises a reflector 70 and an optical film unit 80. The reflector 70 is disposed between the back bezel 20 and the LGP 30. The optical film unit 80 is disposed above the LGP 30.

In the present embodiment, the mounting bracket for QD strips 60 comprises an upper portion 60a. The upper portion 60a extends above the LGP 30. At least a part of the optical film unit 80 is placed on the upper portion 60a.

The light source 40 generates light. The light passes through the QD strip 10, resulting in fluorescent substances excited from the QD strip 10. With the fluorescent substances, the light source 40 generates light having a broader color gamut. The light having a broader color gamut emits into the LGP 30. The light emits from the upper side of the LGP 30, penetrating the optical film unit 80, and finally emits into the liquid crystal panel 300.

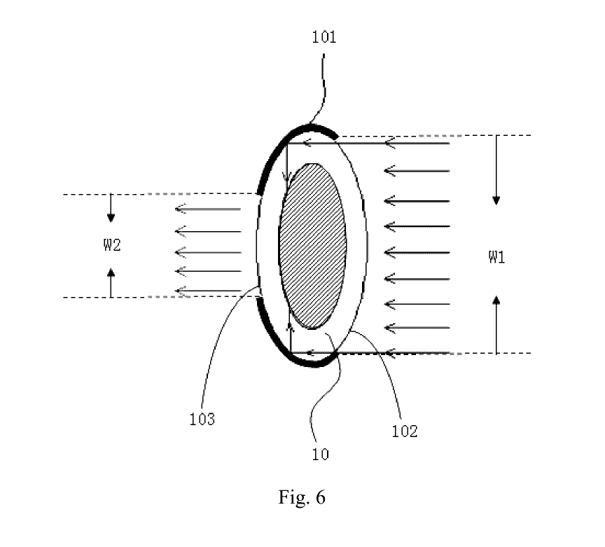

Please refer to FIG. 5. The mounting bracket for QD strips 60 comprises a receiving slot 61, an incident slot 62, and an emergent slot 63. The mounting bracket for QD strips 60 is connected to the receiving slot 61. The receiving slot 61 is used for emplacing the QD strip 10. The incident slot 62 faces towards the light source 40. The emergent slot 63 faces towards the LGP 30. Further, a reflective layer 101 is coated on or adheres to partial periphery of the QD strip 10. An incident opening 102 and an emergent opening 103 are formed on the periphery of the QD strip 10 because of the reflective layer 101. In this embodiment, the reflective layer 101 is disposed on upper and lower portions of the QD strip 10 by coating silver paste. The reflective layer 101 leans towards one side of the QD strip 10. The reflective layer 101 is symmetrical above and below. The other portions, which are not coated with silver paste, form the incident opening 102 and the emergent opening 103. The incident opening 102 and the emergent opening 103 are symmetrically disposed opposite on the left and right sides of the QD strip 10. Also, the width of the emergent opening 103 is smaller than a width of the incident opening 102.

The incident opening 102 corresponds to the incident slot 62. The emergent opening 103 corresponds to the emergent slot 63. Specifically, the width of the incident slot 62 is not smaller than a width of the incident opening 102. The width of the emergent slot 63 is not smaller than the width of the emergent opening 103. In the present embodiment, a width of the incident opening 102 is the same as the width of the incident slot 62. The width of the emergent opening 103 is the same as the width of the emergent slot 63.

The light source 40 primarily adopts light-emitting diode (LED) lamps. The light source 40 may comprise an LED strip 40a or a plurality of LED strips 40a.

Please refer to FIG. 5 and FIG. 6. The width W1 of the incident opening 102 should not be smaller than the width H of the light source 40. The width W2 of the emergent opening 103 should not be larger than the thickness T of a light input surface of the LGP 30. Here, the width H of the light source 40 mainly refers to the width of the illuminating area. For example, when the light source 40 comprises a single LED strip 40a, the width H of the light source 40 is the width of the LED strip 40a. When the light source 40 comprises a plurality of LED strips 40a arranged side by side, the width H of the light source 40 is the sum of the width of each of the plurality of LED strips 40a. Specifically, in FIG. 5, the light source 40 comprises two LED strips 40a arranged side by side. The width H of the light source 40 is the sum of the widths of the two LED strips 40a.

FIG. 6 illustrates a travel route of light generated by the light source emitting into the QD strip 10 through the incident opening 102 with a larger width, some of the light being reflected by the reflective layer 101 and then emitting into the QD strip 10, and the light emitting out of the emergent opening 103 with a smaller width. Therefore, the QD strip 10 comprising the reflective layer 101 has functions of light mixing and light condensing.

To sum up, the reflective layer 101 in the backlight module 100 proposed by the present embodiment of the present invention is coated on or adheres to partial periphery of the QD strip 10. The incident opening 102 and the emergent opening 103 are formed on the periphery of the QD strip 10 because of the reflective layer 101. Also, the width of the emergent opening 103 is smaller than a width of the incident opening 102. The light generated by the light source emits into the QD strip 10 through the incident opening 102 with a larger width. Some of the light is reflected by the reflective layer 101 and then emits into the QD strip 10. Finally, the light emits out of the emergent opening 103 with a smaller width and enters the LGP 30. Therefore, the QD strip 10 comprising the reflective layer 101 has functions of light mixing and light condensing. While a larger demand of luminous flux is satisfied, the use of the QD strip does not increase in numbers. Thus, the overall production cost is reduced.

The terms “a” or “an”, as used herein, are defined as one or more than one. The term “another”, as used herein, is defined as at least a second or more. The terms “including” and/or “having” as used herein, are defined as comprising. It should be noted that if it is described in the specification that one component is “connected,” “coupled” or “joined” to another component, a third component may be “connected,” “coupled,” and “joined” between the first and second components, although the first component may be directly connected, coupled or joined to the second component.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A backlight module comprising quantum dot (QD) strips, comprising a back bezel, a light guide plate (LGP) disposed on the back bezel, and a light source fixed at one side of the LGP, a QD strip disposed between the light source and the LGP wherein a reflective layer is coated on or adheres to partial periphery of the QD strip, an incident opening and an emergent opening are formed on the periphery of the QD strip because of the reflective layer, the incident opening faces towards the light source, the emergent opening faces towards the LGP, and the width of the emergent opening is smaller than a width of the incident opening.

2. The backlight module comprising QD strips as claimed in claim 1, wherein a mounting bracket for QD strips is disposed on the back bezel, the mounting bracket for QD strips comprises a receiving slot connected to the mounting bracket for QD strips itself, an incident slot, and an emergent slot, the receiving slot is used for emplacing the QD strip, the incident slot corresponds to the incident opening, and the emergent slot corresponds to the emergent opening.

3. The backlight module comprising QD strips as claimed in claim 2, wherein the reflective layer is symmetrically disposed on upper and lower portions of the QD strip, and the incident opening and the emergent opening are symmetrically disposed opposite on both sides of the QD strip.

4. The backlight module comprising QD strips as claimed in claim 2, wherein a width of the incident opening is not smaller than the width of the light source, and the width of the emergent opening is not larger than the thickness of a light input surface of the LGP.

5. The backlight module comprising QD strips as claimed in claim 2, wherein the light source comprises at least one light-emitting diode (LED) strip.

6. The backlight module comprising QD strips as claimed in claim 1, wherein a width of the incident opening is not smaller than the width of the light source, and the width of the emergent opening is not larger than the thickness of a light input surface of the LGP.

7. The backlight module comprising QD strips as claimed in claim 5, wherein a width of the incident opening is not smaller than the width of the light source, and the width of the emergent opening is not larger than the thickness of a light input surface of the LGP.

8. The backlight module comprising QD strips as claimed in claim 6, wherein the backlight module further comprises a reflector, and the reflector is disposed between the back bezel and the LGP.

9. The backlight module comprising QD strips as claimed in claim 6, wherein the backlight module further comprises an optical film unit, the optical film unit is disposed above the LGP, the mounting bracket for QD strips comprises an upper portion which extends above the LGP, and at least a part of the optical film unit is placed on the upper portion.

10. The backlight module comprising QD strips as claimed in claim 6, wherein a heat sink is disposed on the back bezel and the light source is disposed on the heat sink.

11. A liquid crystal display (LCD) device, comprising:
a liquid crystal panel; and
a backlight module, disposed opposite to the liquid crystal panel, the backlight module supplying the liquid crystal panel with an illuminating light source so that the liquid crystal panel can show images, the backlight module comprising: a back bezel, a light guide plate (LGP) disposed on the back bezel, and a light source fixed at one side of the LGP, a quantum dot (QD) strip disposed between the light source and the LGP wherein a reflective layer is coated on or adheres to partial periphery of the QD strip, an incident opening and an emergent opening are formed on the periphery of the QD strip because of the reflective layer, the incident opening faces towards the light source, the emergent opening faces towards the LGP, and the width of the emergent opening is smaller than a width of the incident opening.

12. The LCD device as claimed in claim 11, wherein a mounting bracket for QD strips is disposed on the back bezel, the mounting bracket for QD strips comprises a receiving slot connected to the mounting bracket for QD strips itself, an incident slot, and an emergent slot, the receiving slot is used for emplacing the QD strip, the incident slot corresponds to the incident opening, and the emergent slot corresponds to the emergent opening.

13. The LCD device as claimed in claim 12, wherein the reflective layer is symmetrically disposed on upper and lower portions of the QD strip, and the incident opening and the emergent opening are symmetrically disposed opposite on both sides of the QD strip.

14. The LCD device as claimed in claim 12, wherein a width of the incident opening is not smaller than the width of the light source, and the width of the emergent opening is not larger than the thickness of a light input surface of the LGP.

15. The LCD device as claimed in claim 12, wherein the light source comprises at least one light-emitting diode (LED) strip.

16. The LCD device as claimed in claim 11, wherein a width of the incident opening is not smaller than the width of the light source, and the width of the emergent opening is not larger than the thickness of a light input surface of the LGP.

17. The LCD device as claimed in claim 15, wherein a width of the incident opening is not smaller than the width of the light source, and the width of the emergent opening is not larger than the thickness of a light input surface of the LGP.

18. The LCD device as claimed in claim 16, wherein the backlight module further comprises a reflector, and the reflector is disposed between the back bezel and the LGP.

19. The LCD device as claimed in claim 16, wherein the backlight module further comprises an optical film unit, the optical film unit is disposed above the LGP, the mounting bracket for QD strips comprises an upper portion which extends above the LGP, and at least a part of the optical film unit is placed on the upper portion.

20. The LCD device as claimed in claim 16, wherein a heat sink is disposed on the back bezel and the light source is disposed on the heat sink.
